(19) United States
(12) Patent Application Publication
(10) Pub. No.: US 2013/0258371 A1
(43) Pub. Date: Oct. 3, 2013

(54) IMAGE FORMING APPARATUS AND UPDATE METHOD

(71) Applicant: TOSHIBA TEC KABUSHIKI KAISHA, Tokyo (JP)

(72) Inventor: Yoshimasa Inoue, Shizuoka-ken (JP)

(73) Assignee: TOSHIBA TEC KABUSHIKI KAISHA, Tokyo (JP)

(21) Appl. No.: 13/850,485

(22) Filed: Mar. 26, 2013

Related U.S. Application Data
(60) Provisional application No. 61/615,991, filed on Mar. 27, 2012.

(51) Int. Cl. H04N 1/00

(52) U.S. Cl. CPC H04N 1/00973
USPC 358/1.11; 358/1.13

(57) ABSTRACT

An image forming apparatus according to an embodiment includes a non-voltage storage unit which stores data, an interface unit which receives data, and a control unit. If a value of a head of first data received by the interface unit is a first value that is defined in advance, the control unit handles the first data as a HEX code and rewrites the data stored in the storage unit with the first data.

### CROSS-REFERENCE TO RELATED APPLICATIONS

This application is based upon and claims the benefit of priority from: U.S. provisional Application No. 61/615,991, filed on Mar. 27, 2012; the entire contents all of which are incorporated herein by reference.

### FIELD

Embodiments described herein relate generally to a technique for downloading data and reflecting the data on an apparatus.

### BACKGROUND

According to the related art, as various update data of firmware (program) and font data in an image forming apparatus, only a binary format file or a HEX format file is used as a target of processing.

In this case, a download application customized for each image forming apparatus is needed.

### DESCRIPTION OF THE DRAWINGS

FIG. 1 shows an example of configuration according to an embodiment.

FIG. 2 shows an example of format of HEX code.

FIG. 3 is a flowchart showing an example of operation according to an embodiment.

### DETAILED DESCRIPTION

In general, according to one embodiment, an image forming apparatus includes a non-voltage storage unit which stores data, an interface unit which receives data, and a control unit. If a value of a head of first data received by the interface unit is a first value that is defined in advance, the control unit handles the first data as a HEX code and rewrites the data stored in the storage unit with the first data.

The apparatus of this embodiment downloads firmware that is accessed in startup of the apparatus and firmware and data that are accessed when controlling a device within the apparatus, from an external computer, and thus updates the firmware and data. As an example of such an apparatus, an image forming apparatus is employed in this embodiment.

The image forming apparatus of this embodiment downloads and updates the following data (the concept of data also includes a program)
IPL FW: a program for downloading and updating firmware. FW is an abbreviation of firmware.
Main FW: a program describing an essential main function of the image forming apparatus from acquisition of image data to output by a printer. The main function of the image forming apparatus may be a printing operation and include various operations such as acquisition of image data, transfer and heating-fixing of toner onto a sheet, and carrying of a sheet to each unit.
CG file: font data used when forming an image on a sheet.

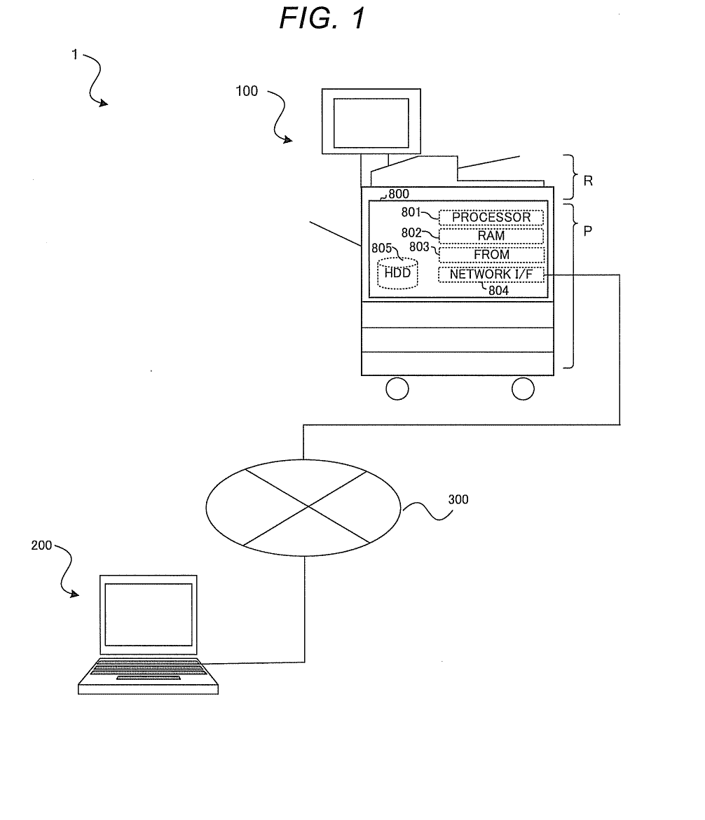

Hereinafter, a form of this embodiment will be described with reference to the drawings. FIG. 1 shows an example of system configuration.

A system 1 includes an image forming apparatus 100 and a computer 200. The image forming apparatus 100 and the computer 200 are connected to each other via a network 300.

The image forming apparatus 100 includes a scanner unit R, an image forming unit P, and a control board 800. The scanner unit R scans a sheet and converts an image formed on the sheet to electronic data.

The image forming unit P forms a toner image on a new or reuse sheet arranged in a cassette. The image forming unit P includes a toner unit, a process unit, and a carrying unit. The toner unit accommodates four colors of cyan, magenta, yellow, and black. The process unit transfers a toner image to the sheet and heats the sheet to fix the toner image thereto. The carrying unit carries the sheet accommodated in the cassette to the process unit and discharges the sheet.

The control board 800 controls hardware inside the apparatus such as the scanner unit R and the image forming unit P. The control board 800 includes a processor 801, a RAM (random access memory) 802, a FROM (flash ROM) 803, a network I/F (interface) 804, and HDD (hard disk drive) 805.

The processor 801 executes a program stored in the FROM 803 or the HDD 805. Thus, the processor 801 instructs and controls each piece of hardware. The processor 801 is, for example, a CPU (central processing unit) or MPU (micro processing unit).

The RAM 802 is a main storage device which performs volatile storing. The FROM 803 is a storage device which performs non-volatile storing. In this embodiment, the FROM 803 can rewrite data. The FROM 803 stores IPL FW, main FW and CG file. The network I/F 804 controls communication with an external device. The network I/F 804 is a LAN (local area network) card in this embodiment but may also be a USB (universal serial bus) standard terminal or RS-323C interface. The HDD805 is a non-volatile magnetic storage device which permanently stores data. The HDD 805 permanently stores data to be used by the user, such as image data scanned by the scanner unit R.

The computer 200 is a portable computer such as a laptop. The computer 200 includes a CPU, a memory as a main storage device, an FROM, an HDD, a LAN card or the like, similarly to a generally known computer. The HDD of the computer 200 stores various files such as IPL FW, main FW and CG file. The computer 200 transmits the stored IPL FW, main FW and CG file to the image forming apparatus 100. The image forming apparatus 100 receives these data and rewrites the IPL FW, main FW and CG file already stored in the FROM 803 with the received data.

If the computer 200 transmits the files of IPL FW, main FW and CG file as binary data, identification information indicating the type of each data, written in the form of ASCII codes, is attached to the head of the data. In this example, the identification information for IPL FW is ‘BL’. The identification information for main FW is ‘MF’. The identification information for CG file is ‘CG’. The identification information at the head of the data is assumed to be attached in advance but may also be attached every time the computer 200 transmits data.

The processor 801 of the image forming apparatus 100 loads the IPL FW currently stored in the FROM 803 into the RAM 802 and executes the IPL FW. Download and update thus start. The image forming apparatus 100 receives binary code data transmitted from the computer 200, via the network I/F 804, and temporarily stores the data in the RAM 802 or the HDD 805. The processor 801 determines which of IPL FW, main FW and CG file the type of this received data is, and writes the data type at a prescribed address within the FROM 803. This determination will be described later.

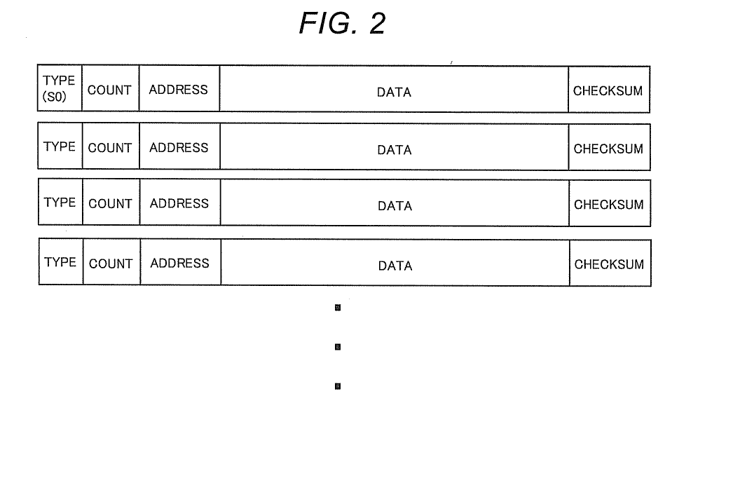

The image forming apparatus 100 can also receive and rewrite IPL FW, main FW and CG file described in HEX codes of hexadecimal numbers, other than the binary data. As an example of HEX codes, the Motorola S-record format will be described. FIG. 2 illustrates the Motorola S-record format. In the Motorola S-record format, the data is all described in ASCII codes and include, from the head of each line, a TYPE field, a COUNT field, an ADDRESS field, a DATA field, and a CHECKSUM field. A return code (not shown) is added at the end and the next line comes.

The TYPE field is a field indicating the type of the line, which is one of ‘S0’ to ‘S9’. The first line usually has ‘S0’ (0×53 0×30) indicating start record. The COUNT field is a field indicating the volume of data (in bytes) described after the COUNT field in the line. The ADDRESS field is a field describing the address where the head of the DATA field in the line is stored. The DATA field is the content of data to be written and is described in the form of hexadecimal numbers and ASCII codes. The CHECKSUM field is a field indicating the checksum value of the line. The image forming apparatus 100 carries out verification using the value of the CHECKSUM field.

Even if HEX code data is received, the processor 801 of the image forming apparatus 100 loads the IPL FW currently stored in the FROM 803 into the RAM 802 and executes the IPL FW, as in the case of the binary data. Download and update thus start.

The image forming apparatus 100 receives HEX code data transmitted from the computer 200, via the network I/F 804, and temporarily stores the data in the RAM 802 or the HDD 805. The processor 801 acquires the first one line and verifies the compatibility of data using the value of the CHECKSUM field. If the verification result shows that the data is compatible, the processor 801 converts the hexadecimal ASCII code in the DATA field into binary data. After the conversion, the processor 801 writes the binary data into the FROM 803. The leading address of the writing destination is the address described in the ADDRESS field. The processor 801 carries out the above operation to all the lines, thus rewriting the existing data in the FROM 803 (IPL FW, main FW, CG file)

The image forming apparatus 100 extracts the characters of the leading 2 bytes (head part) of the data transmitted from the computer 200. If the extracted data is ‘S0’ of ASCII codes, the image processing apparatus 100 carries out update processing as HEX code format. If not, the image forming apparatus 100 carries out update processing as binary data.

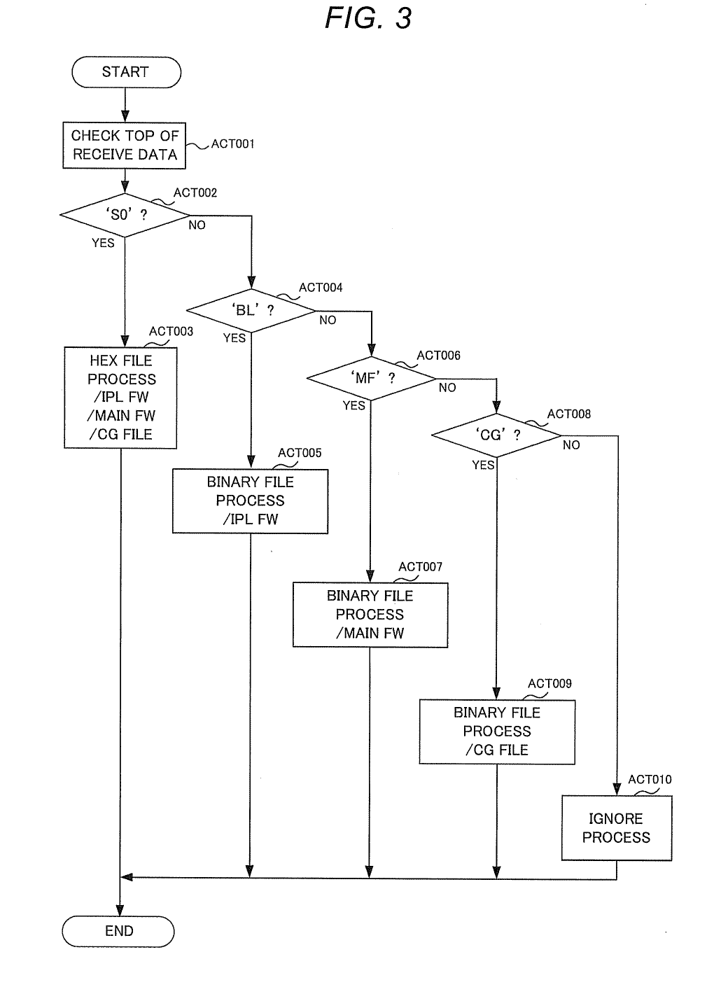

FIG. 3 is a flowchart showing an example of operation of the image forming apparatus 100. This is a flowchart showing an operation example where the type of data transmitted from the computer 200 is specified.

The computer 200 transmits one or plural files of IPL FW, main FW and CG file. The network I/F 804 of the image forming apparatus 100 receives the transmitted data. The RAM 802 or the HDD 805 temporarily stores the received data.

The processor 801 extracts and checks the leading 2 bytes of the received data (ACT 001). If the leading 2 bytes are ‘S0’ (ACT 002, Yes), the processor 801 considers the received data to be HEX data and updates the data already stored in the FROM 803 with the received data (ACT 003).

If the leading 2 bytes are not ‘S0’ (ACT 002, No), the processor 801 determines whether the leading 2 bytes are ‘BL’ (ACT 004). If these bytes are ‘BL’ (ACT 004, Yes), the processor 801 considered the transmitted data to be FW binary data and updates the data (ACT 005).

If the leading 2 bytes are not ‘BL’ (ACT 004, No), the processor 801 determines whether the leading 2 bytes are ‘MF’ (ACT 006). If these bytes are ‘MF’ (ACT 006, Yes), the processor 801 considers the transmitted data to be main FW binary data and updates the data (ACT 007).

If the leading 2 bytes are not ‘MF’ (ACT 006, No), the processor 801 determines whether the leading 2 bytes are ‘CG’ (ACT 008). If these bytes are ‘CG’ (ACT 008, Yes), the processor 801 considers the transmitted data to be CG file binary data and updates the data (ACT 009). If these bytes are not ‘CG’ (ACT 008, No), the data corresponds to none of the above and therefore the processor 801 ignores the data (ACT 010) and ends the processing.

In this embodiment, the storage address of IPL FW, main FW and CG file within the FROM 803 is predetermined. In ACT 005, ACT 007 and ACT 009, the respective data of IPL FW, main FW and CG file is written at this predetermined address. In this case, the processor 801 removes the leading 2 bytes (the area where ‘BL’, ‘MF’ or ‘CG’ is described) and writes the remaining binary data in the FROM 803.

Also, in the update of HEX code data in ACT 003, the processor 801 can determine which of IPL FW, main FW and CG file the present file is, based on the value described in the ADDRESS field. The update operation of HEX code data is carried out as described above.

In the above example, the Motorola S-record format is used as an example of HEX code format. However, other formats may also be used. For example, in the Intel-HEX format, a colon ‘:’ is attached to the head. The processor 801 extracts the leading 1 byte of data and determines whether this byte is a colon. Thus, whether the format is the HEX code format can be determined.

In the above example, the image forming apparatus is used as an example. However, the technique can also be applied to other apparatuses such as computer, communication apparatus, and carrier apparatus.

By applying the above example, the image forming apparatus can determine whether a download file transmitted to the printer is HEX format data or binary data and carry out download processing corresponding to the file type, without using a download application. By employing such a configuration, both binary data and HEX code data can be downloaded.

In the embodiment, the case where a function to carry out the invention is recorded in advance within the apparatus is described. However, the provision of such a function is not limited to this example, and a similar function may be downloaded to the apparatus from a network or a similar function stored in a recording medium may be installed in the apparatus. The recording medium may be of any form that can store a program and is readable by the apparatus, such as CD-ROM. Also, the function obtained by installing or download in advance in this manner may be realized in collaboration with the OS (operating system) within the apparatus.

As described above in detail, according to the technique described herein, data can be transmitted and data can be updated while the user is not aware whether the data is binary data or HEX data.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
a non-voltage storage unit which stores data;
an interface unit which receives data; and
a control unit which, if a value of a head of first data received by the interface unit is a first value that is defined in advance, handles the first data as a HEX code and rewrites the data stored in the storage unit with the first data.

2. The apparatus according to claim 1, wherein if the value of the head of the first data is a value of SO of ASCII codes, the control unit handles the first data as HEX code data.

3. The apparatus according to claim 1, wherein if the value of the head is not the first value, the control unit handles the first data as binary data and rewrites the data stored in the storage unit with the first data.

4. The apparatus according to claim 3, wherein if the value of the head is a value that is different from the first value and that is defined in advance, the control unit determines a type of the first data based on the value.

5. The apparatus according to claim 1, wherein the data stored in the storage unit and the first data are one or a plurality of a program which causes the apparatus to carry out the rewriting, font data of the apparatus, and a program which causes the apparatus to carry out printing.

6. A method for rewriting data stored in a non-volatile storage unit in an apparatus, the method comprising
causing the apparatus to:
receive first data from an interface unit in the apparatus; and
if a value of a head of the first data is a first value that is defined in advance, handle the first data as a HEX code and rewrite the data stored in the storage unit with the first data.

7. The method according to claim 6, wherein if the value of the head of the first data is a value of S0 of ASCII codes, the first data is handled as HEX code data.

8. The method according to claim 6, wherein if the value of the head is not the first value, the first data is handled as binary data and the data stored in the storage unit is rewritten with the first data.

9. The method according to claim 8, wherein if the value of the head is a value that is different from the first value and that is defined in advance, a type of the first data is determined based on the value.

10. The method according to claim 6, wherein the apparatus is an image forming apparatus, and
the data stored in the storage unit and the first data are one or a plurality of a program which causes the apparatus to carry out the rewriting, font data of the apparatus, and a program which causes the apparatus to carry out printing.
